(19) United States
(12) Patent Application Publication
(10) Pub. No.: US 2003/0044331 A1
(43) Pub. Date: Mar. 6, 2003

(54) Annular heat exchanging reactor system

(75) Inventors: Crispin L. DeBellis, North Canton, OH (US); William R. Gwynne, Beloit, OH (US); Milind V. Kantak, Mayfield Heights, OH (US); Timothy A. Fuller, North Canton, OH (US)

Correspondence Address: McDermott Incorporated, Alliance Research Center, Patent Department, 1562 Beeson Street, Alliance, OH, 44601-2196, US

(73) Assignee: McDERMOTT TECHNOLOGY, INC., New Orleans, LA

(21) Appl. No.: 09/944,541

(22) Filed: Aug. 31, 2001

(51) Int. Cl. B01J 8/00; F28D 21/00; G05D 23/00

(52) U.S. Cl. 422/198; 422/109; 422/205; 422/218; 422/173; 422/177; 422/181; 422/211

(57) ABSTRACT

An annular heat-exchange reactor vessel allows for selectively controlled heat transfer between a first fluid and second fluid flowing through the vessel. Optionally, catalyst means may be added to further convert either fluid into a desired end product. In this regard, it is envisioned that the present invention will have particular utility in fuel processing systems. Additional, in-line upstream or downstream annular modules may also be incorporated to create a more complete, efficient and/or compact system. Various methods for constructing this reactor system are also disclosed.

The present invention was developed under government contracts: CRD Contract #1366, RDD #43604 and CRD Contract #1400, DOE No. DE-FC02-99EE50586. Accordingly, the United States' government may retain certain rights to the disclosed invention.

### BACKGROUND OF THE INVENTION

1. Field of the Invention

The present invention generally relates to annular heat-exchanging reactor systems and, more particularly, to improvements to the reactor vessels of fuel processor systems which require efficient and effective heat transfer.

2. Description of the Prior Art

Combustion-based energy systems bum fuel to create thermal energy which can be used directly for heating purposes or which can be converted to mechanical and/or electrical energy. A heat exchanger or recuperator is used in such systems to boost system efficiency by transferring the unused energy in the exhaust gases to incoming combustion air. Examples include: high-efficiency home heating furnaces; radiant tube burners with recuperators (heat exchanger); boilers with economizers; and thermophotovoltaic systems. Typically, heat exchangers in these particular types of systems have a number of limitations including mid-range temperature operation because of the temperature and corrosion limits of cost-effective materials, and size and efficiency limits due to cost and weight restrictions.

Fuel cell systems are an example of a particular energy system which relies upon efficient and effective heat transfer and utilization. Fuel cells convert hydrogen-rich gas into electricity. Because fuel cell systems are often smaller than tradiational power generation equipment, such fuel cell systems can be modified for a wide variety of uses—from stationary, decentralized energy supplies to mobile, primary energy sources for automobiles, naval vessels and/or other vehicles.

Insofar as fuel cell systems and other combustion-based energy systems rely upon hydrogen-rich gas as a fuel, systems which produce such hydrogen-rich gas (hereafter referred to as “fuel processor systems”) are of particular interest. At present, economic and practical aspects dictate that only universally available and generally accepted hydrocarbon-feed fuels can be considered for hydrogen rich gas generation. Natural gas is particularly attractive for stationary applications, whereas use of liquid hydrocarbon fuels is more likely in the mobile sector.

Typically, the desired hydrogen-rich gas will contain a mixture of H₂; H₂O; CO; and CO₂. The intended use of hydrogen-rich gas often requires the hydrogen-rich gas to have a specific chemical composition (especially in regards to fuel cell systems, which are easily poisoned by certain unwanted elements, such as sulfur or carbon monoxide), and the typical hydrocarbon-feed fuel may also need to be treated prior to reforming. “Reforming” is a general term of art which describes the specific process within a fuel processing system for actually converting hydrocarbon fuels (such as natural gas, gasoline and diesel) into hydrogen-rich gas. Consequently, reforming processes are usually combined with various other chemical processes, such as desulfurization, selective oxidation and other known purification/treatment processes, to create a fully integrated, coherent fuel processor system that is tailored to an intended use.

Not surprisingly, considerable attention has been focused on identifying and improving economical and efficient fuel processor systems. To the extent that many fuel processor systems involve combustion-based reactions, effective thermal design of any fuel processor system is a must.

Numerous methods are available to convert hydrocarbon base fuels into hydrogen rich gas. For example, steam-reforming, partial oxidiation (POX) reforming and auto-thermal (ATR) reforming are all distinct and separate methods for producing hydrogen-rich gas. Each of these methods typically involve some sort of heat-exchange reaction. Not surprisingly, each method may also require a different type of reactor to achieve optimal results.

In ATR, fuel is partially reacted by adding air to the fuel and steam mixture in the reformer to heat it to the appropriate reaction temperatures. ATR is advantageous because it has lower steam requirements (e.g. a molar steam to carbon ratio of about 2.5 to 3.5) than steam reforming (see below) and it requires smaller, lighter equipment in comparison to steam-reforming. ATR relies on flameless oxidation of oxygen from the air, thereby resulting in combustion of about 20 to 33% of the fuel and a release of the heat needed to drive the ATR reforming reactions.

The unoxidized fuel endothermically reacts with steam to create a mixture of hydrogen, carbon monoxide and carbon dioxide. An ATR reformer quickly adapts to new operating conditions because of its direct coupling and dynamic ability to respond to changing loads. Furthermore, ATR does not require additional external burners (and their attendant power supplies), making the system less complex and less expensive. An ATR reactor is described in U.S. patent application Ser. No. 09/710,173, which is incorporated by reference herein.

Partial oxidation (POX) reactors comprise yet another distinct reforming process. The POX process can be more thermally efficient than steam reforming, thereby lowering the amount of fuel originally required in comparison to conventional steam reforming. POX reactors are also more attractive than steam reformers because of a POX reactor's ability to handle a wider variety of fuels (i.e., natural gas (either with or without sulfur), coal, bitumen, coke, resid, biomass, etc.). Finally, POX reactors can typically use sulfur-bearing liquid fuels that are not well suited to steam reforming without pre-treatment.

Most POX reactors operate by introducing steam, fuel, and an oxidant into a vessel. The oxidant is either air, pure oxygen or mixtures thereof. In turn, a large amount of heat (i.e., enough to heat the products to upwards of 2000° F.) is released, thereby obviating the need for extra external burners. A POX reactor is described in U.S. patent application Ser. No. 09/606,467, which is incorporated by reference herein.

Steam reforming can be performed in a variety of reactors. In any case, the reforming process is endothermic, thereby requiring a heat energy source. Typically, fuel is combusted in the presence of steam and a catalyst to produce the desired hyrdrogen-rich gas. Of particular note, one steam reforming reactor uses a packed bed reactor vessel. In this arrangment, the packed bed is formed with a pelletized ceramic material, like alumina, on which a catalyst, usually a precious metal, is applied. The ceramic material is called the catalyst support structure. However, packed beds are usually large and heavy. A packed bed steam reformer is described in U.S. Pat. No. 5,938,800, which is incorporated by reference herein.

A final type of reforming reactor is the plate reformer. In a plate design, a series of plates form distinct channels dedicated to either combustion or reforming reactions. Each channel contains and/or is coated with a catalyst to initiate and assist the chemical reactions occurring therin. The combustion channels generate heat which is then conveyed through the plate into the reforming channels. The reforming reaction utilizes this heat energy to create hydrogen rich gas. Hydrogen rich gas is then drawn from the reforming channels. A plate based reformer is described in U.S. patent application Ser. No. 09/808,768, which is incorporated by reference herein. Notably, the operating design of plate reforming reactor is similar to that of a typical heat-exchanger reactor.

Experts predict a shift toward a more hydrogen-based economy in the near future. In this situation, hydrogen rich gases will become the fuel of choice for a wide array of devices, including vehicles, ships, and buildings, so that the ability to reform current, widely available hydrocarbon fuels will increase in importance. As this occurs, the need for light-weight, compact reformer and/or fuel processor systems which may be adapted for use in a variety of mobile and/or stationary applications will increase.

Fuel processing systems currently under development for automotive fuel cell applications must operate over a wide range of conditions. Typically, these conditions range from idle (5% load) to full power (100% load). These systems contain a number of heat exchangers that must provide critical temperatures at key points in the process for the system to function optimally. Properly sizing these heat exchangers to handle the wide range of conditions, yet still providing the critical temperatures as required, is a challenge for fuel processor system designers.

Two approaches for sizing heat exchanging apparati are known. The first approach is to size the heat exchangers at the design load (normally, 25% load) to provide critical temperatures at different points in the fuel processor system. This methodology provides the optimal configuration at design load, but this configuation cannot provide the same critical temperatures at off-design loads because of changes in mass flows through the exchangers caused by changes in the load (e.g., idle load, full load, etc.).

The second design approach is to size the heat exchangers for full load operation. Partial-load operation is then accomplished with complicated bypass systems around every heat exchanger. Variable-area heat exchangers would solve these problems by changing their heat transfer surface area in response to a change in load.

Annular reactor vessels have been designed for use in heat-exchanging, reforming and fuel processing operations. U.S. Pat. No. 4,909,808 (Steam Reformer with Catalytic Combustor) discloses a steam reformer having an annular steam reforming catalyst bed formed by concentric cylinders and having a catalytic combustor located at the center of the innermost cylinder. The fibrous dome and walls of the combustor are coated with a catalyst to promote catalytic combustion. The flowpath for gases in this reformer is tortuous, and ultimately flows radially outward from the gases' introduction point. This tortuous flowpath requires additional construction materials (e.g., more than one set of tubes is required to create the reforming and combustion chamber) and it makes simple, in-line integration of de-sulfurizers, pre-reformers, and heat exchangers (sometimes needed to remove heat from the hydrogen rich gas exiting the reformer) impractical and difficult to integrate.

U.S. Pat. No. 5,164,163 (Hydrocarbon Reforming Apparatus) also discloses a hydrocarbon reforming apparatus made up of an inner cylinder, a middle cylinder and an outer cylinder. The inner cylinder functions as a combustion gas passage, and may be filled with an alumina-based combustion catalyst. Other annular passages are filled with reforming catalyst. Again, the flowpath is tortuous and gases flows radially outward from the introduction point.

U.S. Pat. No. 5,938,800 (Compact Multi-fuel Steam Reformer) discloses an annular apparatus. Similar to the two patents above, this apparatus requires simultaneous combustion and reforming reactions in the same general flowpath/area. Further, it requires a tortuous flowpath radially out from the reactor.

Given all of the above, a reactor having a geometry which allows for more compact size and more efficient operation would be welcome, as would a system that can be easily integrated into a reforming system and/or an overall fuel processor system for the production of hydrogen-rich gas. In particular, a reactor with a geometry which allows the addition of additional in-line systems (i.e., a pre-reformer, reformer and/or post-reformer heat exchanger) is needed. Finally, a vessel design that can adapt to changes in load and that is compatible with other processes in a complete fuel processor system would be welcome.

### SUMMARY OF THE INVENTION

The present invention solves the problems associated with prior art heat-exchanging annular reactors by providing a lighter, more compact, and more efficient annular reactor vessel having a variable heat exchange control system. The present invention is also easily adapted for use in fuel processing systems and allows for other annular in-line systems (fuel processing or otherwise) to be easily incorporated and controlled.

An object of the present invention is to provide a readily adaptable heat exchanging annular reactor vessel. It is a further object of this invention to describe a vessel which may be used in fuel processor systems and/or other systems which use annular, in-line geometry and which require efficient, economical heat exchange between gases. A final object of the present invention is to provide an annular reactor vessel which allows for variable or selective control of the heat-exchange processes occurring therein.

Accordingly, a longitudinal gas-gas heat exchanging reactor vessel comprises a central tube with longitudinal fins on the outside diameter and/or inside diameter of the tube. An outer shell fits over the outer fins and an inner shell fits inside the inner fins. Thus, two multichannel annular flow regions are created. Control means, preferably in the form of a variably sized cover, is located at a terminal end of the vessel in order to control the flow of fluids therethrough. The percentage of the inlet end that is blocked by the cover is changed depending on the load presented at the inlet end.

The fins assist in heat-exchange operations and may be further modified to contain or be coated with catalysts for specific, desired reactions (including but not limited to those involved in fuel processor systems). Further, the construction of the present invention allows for multiple fluids to flow through the vessel in counter-flow or, more preferably, a co-flow arrangements which have particular utility with fuel processor systems and/or other heat exchanging reactor systems. In the case of a fuel processor, the fuel/steam mixture most preferably flows in the inner annulus and the fuel/air combustion mixture flows in the outer annulus. The relative locations of the two streams are interchangeable.

A method for constructing a heat exchanging reactor vessel is also disclosed. Essentially, this method requires providing concentric cylinders and placing fins on each. Optionally, a catalyst coating may be added. Extrusion, electrical discharge machining (EDM), or standard joining methods (welding, brazing, etc.) may be used to form the fins and/or the tubes. Control means are also added to permit selective control of the fluids passing through the final product. The overall assembly is then sealed and provided with manifolding to complete the desired assembly.

These and other aspects of the present invention will be more fully understood upon a review of the following description of the preferred embodiment when considered in conjunction with the drawings.

### BRIEF DESCRIPTION OF THE DRAWINGS

In the drawings:

FIG. 1 is a perspective sectional view of the annular reactor assembly of the present invention;

FIG. 2 is a perspective sectional view of the annular reactor assembly of the present invention configured for a partial load flowing therethrough;

FIG. 3 is a perspective sectional view of the annular reactor assembly of the present invention configured for a low load flowing therethrough;

FIG. 4 is a sectional view of the annular reactor assembly of the present invention;

FIG. 5 is a sectional view of a second embodiment of the annular reactor assembly of the present invention;

FIG. 6 is a perspective sectional view of the present invention demonstrating fluid flow paths therethrough; and

FIG. 7 is a perspective view of the present invention as it may be incorporated into a more complete, modular heating-exchanging system, such as a fuel processor system.

### DESCRIPTION OF THE PREFERRED EMBODIMENT

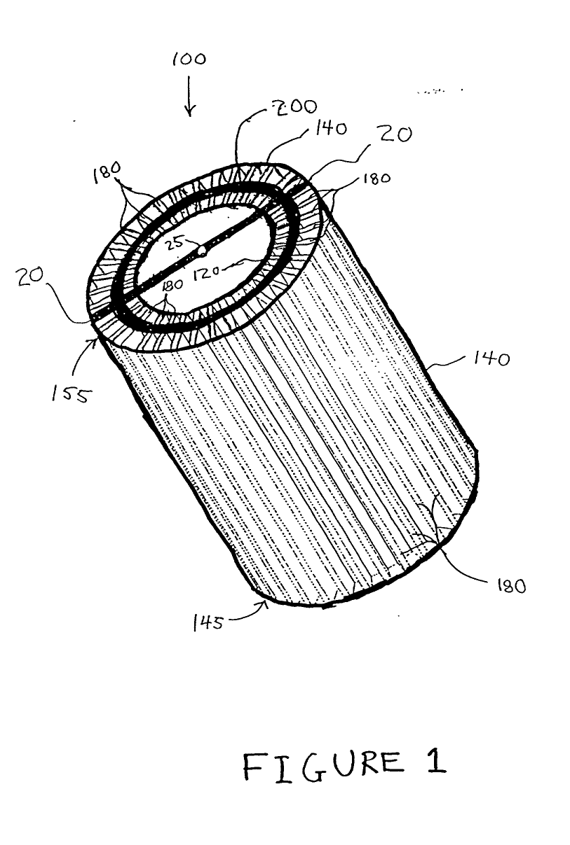

Referring now to the drawings, in which like reference numerals are used to refer to the same or similar elements, FIG. 1 shows an annular heat-exchange vessel 100 having a generalized inlet end 155 and outlet end 145. A central core structure 200 supports a plurality of inner and outer diameter fins 180. Inner and outer cylinders 120, 140 respectively fit over the inner and outer fins 180 to form two multi-channel annular flow regions around central structure 200. Flow control means 20 having a center 25 is positioned over the inlet end 155. Additionally or alternatively, flow control means 20 can be positioned at the outlet end of vessel 100. Also, the inlet end 155 should be properly manifolded to receive incoming fluids source for transferring heat and or other reactions which occur within vessel 100, while outlet end 145 would also be properly manifolded to remove fluids as desired.

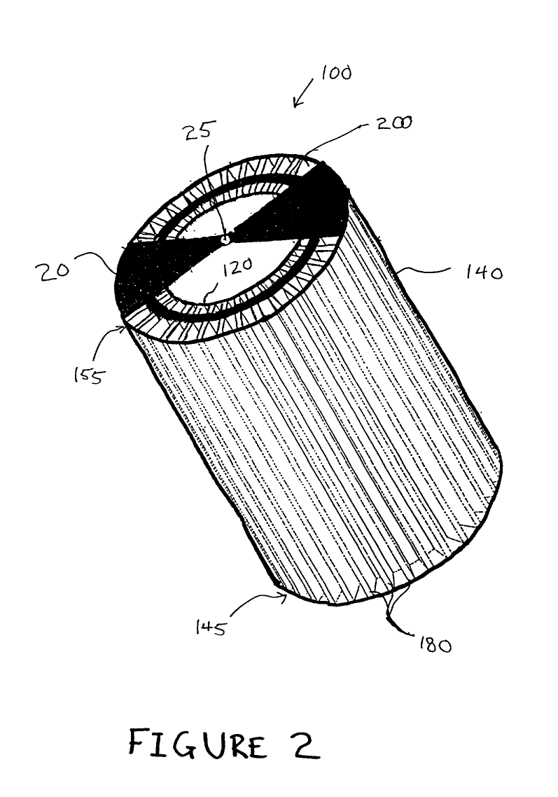

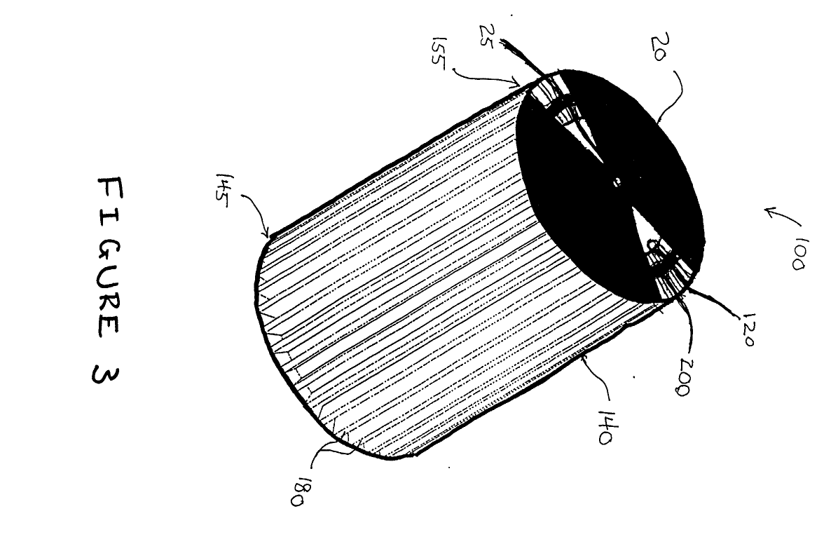

FIGS. 2 and 3 show more detailed embodiments of flow control means 20. As seen in FIGS. 2 and 3, control means 20 ideally takes the form of a cover capable of being configured into different positions. Each position would selectively vary the amount of load flowing into the vessel 100. As seen in FIG. 2, control means 20 is partially closed for a lower load than full operation, such as a 50% load. In contrast, as in FIG. 3, control means 20 can instead be almost completely closed for use at very low loads. Notably, FIGS. 2 and 3 are merely illustrative and control means 20 may optimally be designed to account for any number of load percentages. In any event, control means 20 can be set to block off different percentages of the annular flow paths formed by the inner and outer fins 180, inner and outer cylinders 120, 140 and core structure 200. Likewise, while a cover is specifically depicted, those skilled in the art will readily adapt any number of known flow-control devices to implement the objects of this invention.

For example, control means 20 may also take the specific form of a valve, pressure regulator or other known means for selectively controlling the flow of gas through an inlet. Most preferably, control means 20 comprises an expandible fan, which pivots on center 25 or a series of overlapping plates which are adjusted relative to one another for greater or lesser flow through the vessel 100. Additionally, an automated system can be connected to the control means 20 to remotely set the percentage of the cover 20 which is open over the inlet end 155 of the heat exchanger 100. A monitoring system (not shown) which was responsive to the fluid temperature and/or composition entering/leaving the reactor vessel 100 could also be incorporated to permit automatic control of the overall system and its end products.

To further illustrate the principles upon which control means 20 is based and designed so that those skilled in the art may readily implement the present invention, the overall heat-exchange veseel 100 described herein relies on the relationships among mass flow rate, heat transfer surface area, and temperature. The mass flow rate, m, through an area A is given by:

m=ρVA_{f}

where:

m=mass flow rate

V=velocity

ρ=density

A_{f}=flow area

Additionally, the temperature of the gas streams are related via the overall heat transfer equation:

Q=UAₕ(∴T)

where:

Q=heat transfer rate

U=overall heat transfer coefficient

Aₕ=heat transfer area

ΔT=temperature difference between the gas streams

The overall heat transfer coefficient is a complex function of the mass flow rate and temperature when the compositions of the heat transfer fluids are fixed. In any event, those skilled in the art will be able to readily identify the proper heat transfer coefficient for any specific use, and design a control scheme as needed. Insofar as control of flow may be achieved, the temperature is also controlled by varying the flow according to the load placed on the fuel processor.

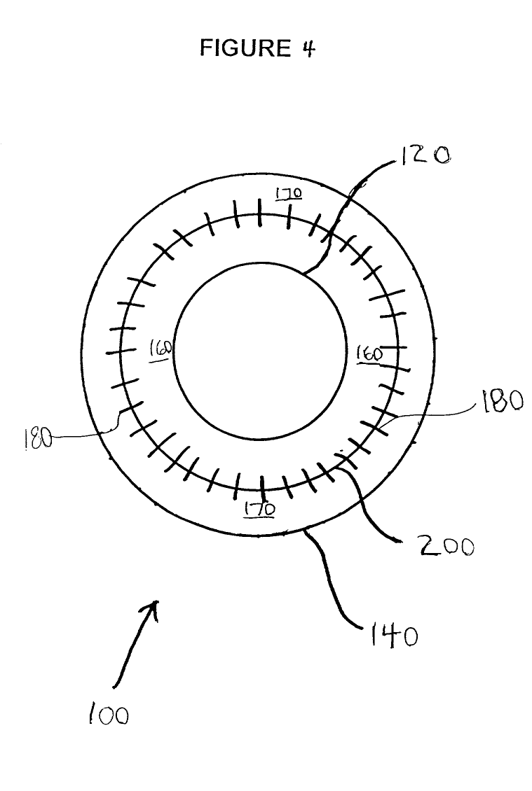

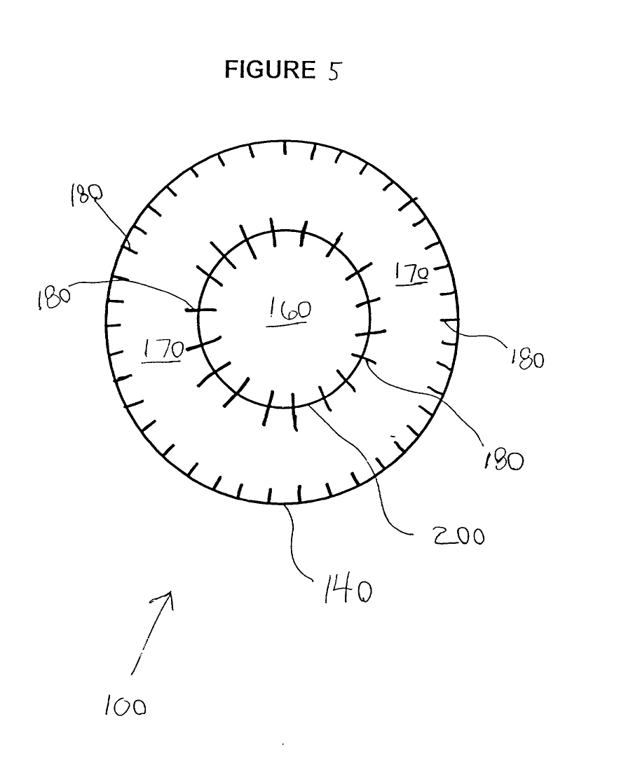

FIGS. 4 and 5 show cross sectional embodiments of the present invention. In FIG. 4, reactor vessel 100 comprises an inner cylinderical structure 120, surrounded by core structure 200 and forms an annular space 160 therebetween. In FIG. 5, cylindrical structure 120 is omitted altogether, although annular space 160 remains intact. In either case, vessel 100 also contains an outer cylinderical structure 140 concentrically disposed around core structure 200 forming annular space 170 therebetween. Notably, as above, control means 20 (not shown in FIGS. 4 and 5) would be placed at the inlet and/or outlet in order to control the load flowing through the vessel 100. In order for control means to work efficiently, fins 180 and cylindrical structures 120, 140, 200 may form a multitude of individual flow channels.

Both inner cylinder 120, outer cylinder 140, and central structure 200 may have a plurality of specially designed circumferential axial fins 180 which extend longitudinally along the entire length of each tube 120, 140, 200. Preferably, the central structure 200 has fins 180 located on both on the inside and outside thereof. Notably, outside tube 140 may also have fins extending only on the inside thereof (but not shown in FIG. 4). And inner tube 120 may also have fins extending only on the outside thereof (but not shown in FIG. 4). Furthermore, fins 180 preferably extend all the way through annular spaces 160, 170 so as to fill the spaces therein. The shape of the fins 180 is selected to optimize heat transfer and/or surface area requirements for the reactions occurring therein. Ultimately, other shapes known to those skilled in the art may be used without departing from the principles of this invention (for example, the teachings of heat exchange fins may be instructive in this regard, including the use of oval, rectangular or triangular geometries). Likewise, while the fins 180 shown in the figures all have an essentially parallel arrangement, the individual fin structures may be placed in any arrangement to optimize the performance of the reformer or to otherwise suit design and/or manufacturing requirements.

Notably, the elements of this invention, and more specifically, center cylinder 200 (having fins 180 on both sides thereof) can be manufactured out of a solid piece of metal using an EDM (electrical discharge machining) machine. However, this method may not be cost effective if produced in large quantities. Alternatively or additionally, the fins 180 could be made from corrugated fin stock and attached (via brazing or other known methods) to the cylinder 200 in the same fashion as other plate-fin heat exchangers are made. The cylinder 200 and fins 180 could also be made by extrusion from metal or ceramic material. To the extent that outer and inner cylinder 120, 140 may also have fins 180, the aforementioned techniques and principles are equally applicable.

As will be readily understood by those skilled in the art, the construction materials for the elements of this invention must be judiciously selected to optimize heat transfer properties. To the extent that the reactor vessel 100 is intended to be used in a more complex heat-exchanging system, such as in a fuel processing system, materials which are compatible with the additional processes are necessary. For example, in the event reactor vessel 100 is used as a reforming module, the interior materials which come into contact with the fluids therein must be capable of retaining a catalyst so as to facilitate the transformation of the incoming fluid(s) into the desired hydrogen-rich gas end product or for combustion of fuel.

Therefore, if the invention is to be used in a fuel processor system, fins 180 and some or all of the interior surfaces in contact with either/both annular spaces 160, 170 are coated with catalyst. In particular, the areas bounding annular space 160, and the fins 180 extending therethrough, will be wash-coated with an appropriate reforming or combustion catalyst using any known catalyst application technique. If tubes 120, 140, 200 are formed from metal, wash-coating is the preferred technique. However, if ceramic material is used, it could serve as the catalyst support. It may also be possible to use combinations of ceramic and metal tubes for the elements of reactor vessel 100. Further, it may be possible to incorporate catalyst coatings directly on or in control means 20 and/or in or on the fins 180.

Catalysts for coating should be selected according to their ability to stimulate the desired reforming and/or combustion reactions. The same catalyst could be used for both the reformer and combustion tubes. Also, it is equally possible to invert the locations of the reforming and combustion catalysts without departing from the principles of this invention. Finally, while a hydrogen reforming system is envisioned, the basic principles of this invention could be applied to any situation wherein separate gas flowpaths in close proximity to each other, with at least one flowpath being in contact with a catalytic material requiring heat-exchange, in order to facilitate the reaction(s) produced thereby. For specific examples of catalyst application, reference is made U.S. Pat. Nos. 5,250,489 and 5,512,250, both incorporated by reference herein.

The heat required for the reforming reaction to create the hydrogen rich gas is supplied by a combustion reaction which occurs on the surfaces of the annular space which is coated with combustion catalyst(s). The heat of combustion is then transferred by conduction through center cylinder 200 and, where appropriate, fins 180. This mode of heat transfer has significantly less resistance then conventional means which usually require additional convection through a vaporous medium.

Regardless of whether the vessel 100 is modified for use in a fuel processor system or a simple heat exchanging reactor, the fin structure is not limited to a continuous rectangular cross section or a simple straight fin. Other configurations for increased heat and mass transfer may include shapes currently used in heat exchangers such as: rectangular offset strip, offset strip, perforated, triangular, louvered or wavy, but the application is not necessarily limited only to these patterns. It is also possible to have some or all of the fins extend completely through one or both of the annular spaces 160, 170 in order to provide structural support for the vessel 100.

When used in a fuel processor system, the fins 180 can also increase the surface area of the catalyst, which significantly reduces the size requirements of the reactor. The fin geometry can be optimized to produce the area required for the catalytic reactions occuring thereon, as well as for better heat transfer. In addition, fins 180 provide a means to evenly distribute the flow over the catalyst surface improving catalyst utilization and, depending upon the shape of the fins 180, may further provide a means for increased mixing of the gas stream that increases mass transfer to and from the surface therefore making the reformer more efficient and smaller.

Notably, to the extent the fins are shaped to enhance and improve flow patterns (whether over a catalyst surface, as in a fuel processor application, or merely over a heat exchange surface), the fin patterns may be altered or varied around the circumference of the core structure 200 and/or the inner and/or out cylinders 120, 140 so as to optimize flow rates performance at the lower loads contemplated in FIGS. 2 and 3. For example, in the event a fan or overlapping plate structure is used as control means 20, it is apparent that the initial flow of fluids into the reactor vessel 100 will only occur at minimal points along the circumference of the vessel 100; therefore, by varying the fin patterns at these points, it is possible to enhance the fluid flow distribution so as to optimize the entire circumference of the reactor.

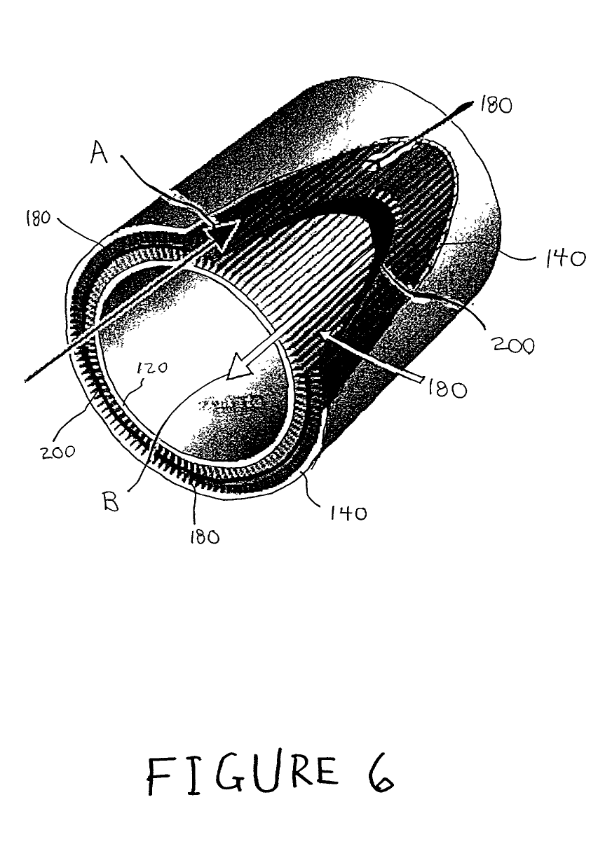

One possible flow arrangement, a counter-flow arrangement, is depicted by flow arrows A, B in FIG. 6. In counter-flow, flow path A passes over the combustion catalyst-coated areas, while flow path B passes in the opposite direction over the reforming catalyst coated area, or vice versa. A co-flow arrangement is also possible.

In any embodiment of this invention, inner core structure 120 may be solid, hollow, or it may be constructed to integrate other elements (either from the heat-exchaning process, the fuel processing system or other, unrelated elements from other systems). Ultimately, those skilled in the art will readily adapt the core structure 120 to suit the needs of the assembly (10) and/or the entire system in which assembly (10) is utilized.

Returning to FIG. 4, it is also possible to remove core structure 120 altogether, so that annular space 160 occupies the entire center of the vessel 100. This particular arrangement could permit the retrofitting of fins 180 onto pipes or other pre-existing structures, and then surrounding the same with outer cylinder 140 and appropriate manifolding and control means 20 in order accomplish the goals of this invention.

Notably, fins 180 may be located on the inner surface of outer cylinder 140. Likewise, fins may be placed on the surface of core structure 120. As above, such fins could be used to facilitate heat transfer, create desire flow patterns within the vessel 100 and/or as structural support for the vessel 100.

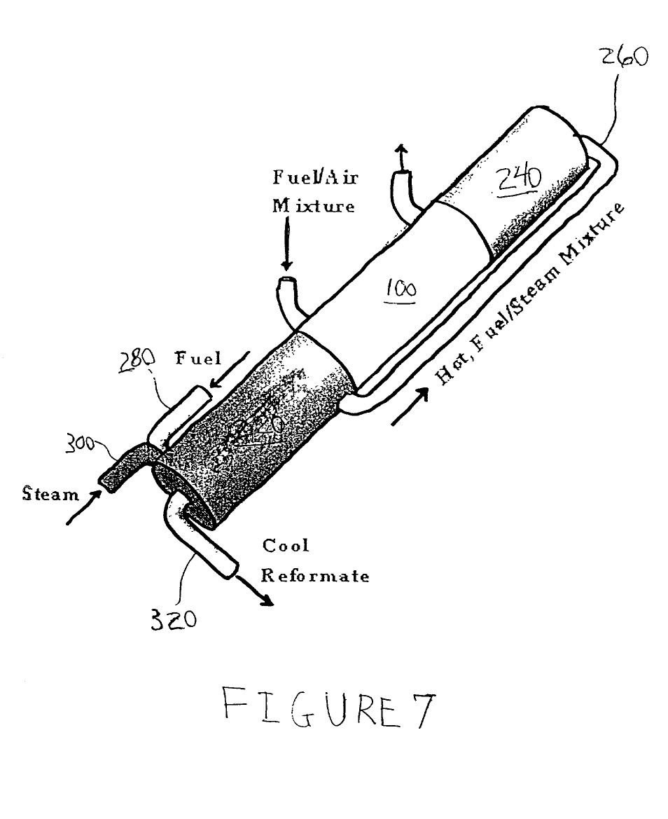

As seen in FIG. 7, the annular geometry of a fuel processing system can be extended upstream and downstream from the basic vessel 100 to provide a heat exchanger 220 and/or other processes 240, including but not limited to desulfurization, prereforming and/or other common fuel processing reactors. These other processes 240 are often used to reduce the feed fuel to lighter hydrocarbons, to assist and enhance the performance of the system and/or to optimize heat usage. Heat exchanger 220 is also used to optimize the thermal performance of the entire system, and may be similar to the type disclosed above or any other appropriate type known to those skilled in the art.

Regardless of the precise processes added (as shown in FIG. 7), all components share the same in-line flow path through a finned annular reactor. However, the fin shapes, sizes and density would be optimized for each section in a known manner. Furthermore, it could be possible to integrate one or both of these structures inside (i.e., as inner structure 120) and/or outside of assembly 100 (not shown), although the extra manifolding, flow patterns, and/or thermal concerns may make this arrangement less desirable. In the event a fuel processing system is contemplated, other processes 240 preferably contains a hot fuel/steam mixture fed from the heat exchanger 220, via line 260. This hot fuel/steam mixture is created by mixing fuel from line 280 with steam from line 300 in proportions as required or desired by the system.

As mentioned above, other processes 240 are normally needed in applications with higher order hydrocarbon fuels, such as gasoline or diesel fuel. The processes 240 can be constructed in accordance with the principles for reactor 100, also discussed above. In particular, processes 240 may require catalyst coatings on the inner fins and/or wall of a different composition which is tailored for pre-reforming reactions (i.e., reactions to produce lower order hydrocarbons, instead of hydrogen rich gas). As an alternative, the inner fins and core of the pre-reformer could be removed and filled with an annular, pre-reforming catalyst bed.

The downstream heat exchanger 220 cools the outgoing reformate prior to any shift reactor or fuel cell applications and heats the fuel/steam mixture prior to the reformer or pre-reformer. The cooled reformate exiting the heat exchanger 220 may be exhausted along line 320.

In view of the foregoing it will be seen that the present invention provides certain advantages over known heat-exchanging systems:

The cylindrical design is efficient for pressure containment.

Use of EDM or extrusion for the central finned tube allows for thermal hydraulic optimization of the fin geometry allows for reduced weight, along with improved flow and thermal transfer properties. For example, a concave pointed fin shaped transfers the maximum heat with minimum pressure drop. This fin shape can also reduce mass by 50% over a rectangular fin.

The fin geometry provides a means to transfer heat between the annular areas of the vessel. The fin structure also provides a means for increased mixing of the gas stream that increases mass transfer to and from the surface therefore making the overall vessel more efficient and smaller.

The fin geometry may provide additional structural support for the assembly.

More particularly, to the extent that the vessel is modified to become part of a fuel processing system, additional advantages are achieved:

The compact annular design integrates the heating and reforming process in a compact unit that is easy to manufacture and integrate into a fuel processing system. Specifically, the reactor vessel, pre-reformer/other processes and/or heat exchangers can be implemented in a modular form providing lower cost, standardized manufacturing, system size flexibility, improved reliability and easier maintenance.

Similarly, the central finned tube can be extended up- and/or down-stream of the reformer to include additional reforming and heat transfer processes. This produces a flow through design which is thermally integrated and has low pressure drop. It also eliminates complicated plenums and piping required by other configurations such as plate heat exchangers. It also eliminates sealing problems.

Heat transfer from the catalytic combustor to the fuel to be reformed occurs by conduction through the finned wall. The combustion and reforming reactions occur on surfaces that are in intimate contact with each other. This is a much more effective way to transfer heat compared to the radiation and convection through the beds taught in U.S. Pat. No. 4,909,808 and 5,164,163. In these patents, combustion and reforming reactions occur on surfaces that are not in intimate contact with each other. Thus, the subject invention has the advantage of the effective heat transfer found with a plate reformer, but without the disadvantages mentioned earlier.

The compact annular finned reformer separates the reforming and heating aspects of the process, which will increase system efficiency and decrease processing equipment size, in comparison to such systems where the reactions occur in the same area.

The heat transfer and temperature profile in the compact annular finned reformer can be tailored to optimize the reforming process.

Certain alternate designs for the present system are considered to be obviously implemented by those skilled in this art area. Examples of such are given below:

Finally, while the terms “combustion” and “reforming” have been used throughout this description, those skilled in the art will readily understand the underlying principles. Specifically, the term “combustion” is synomous with any exothermic reaction. By the same token “reforming” is interchangeable with any and all endothermic reactions. As such, the reactor design contemplated herein may be applicable to any area requiring heat exchange between an endothermic process(es) and an exothermic process(es).

Alternative 1: Although one large reactor is envision, the design may also be implemented in smaller modules. Small tube reactors could be placed in parallel. This may simplify manufacturing and allow for system size variation without redesign. Modules also tend to improve reliability and simplify maintenance.

Alternative 2: As mentioned above, the fin structure is not limited to a continuous rectangular cross section. Other configurations for increased heat and mass transfer may include shapes currently used in heat exchangers such as: rectangular offset strip, offset strip, perforated, triangular, louvered or wavy, but are not limited to these.

Alternative 3: In regards to a reactor specifically designed for a fuel processing system, the vessel could be made more compact by including the reformate cooling process within the reformer by adding a multiple finned annuli containing the preheating fuel/steam mixture. If the surface area of the fins is insufficient for reforming, additional pelletized catalyst could also be used to fill in the space between the fins. The fin structure would provide fast, uniform bed heating as well as high reformer surface area.

It will be understood that these and other obvious modifications and implementations are considered to fall within the scope of the following claims.

We claim:

1. An annular reactor assembly for exchanging heat between at least two separate fluid streams flowing therethrough, the reactor comprising:
an inner cylinder forming an inner area;
an outer cylinder surrounding the inner outer cylinder and forming an annular area therebetween;
fins which extend at least partially into at least one of the: inner area and the annular area and which are oriented in an essentially longitudinal direction along a circumference of at least one of: the inner tube and the outer tube; and
control means for selectively controlling heat transfer between a first fluid passing through the inner area and a second fluid passing through the annular area, the control means being connected to a terminal end of at least one of: the inner cylinder and the outer cylinder.

2. An annular reactor according to claim 1, wherein the control means comprises a variable cover.

3. An annular reactor according to claim 2, wherein the variable cover comprises plurality of overlapping plates fixed to a central pivot.

4. An annular reactor according to claim 2, wherein the variable cover comprises an expanding fan fixed to a central pivot.

5. An annular reactor according to claim 1, wherein the control means includes an automated system for monitoring at least one of: the first fluid and the second fluid, and for responsively altering the heat transfer between the first fluid and the second fluid in order to achieve a desired operating state.

6. An annular reactor according to claim 1, further comprising a central core structure located within the inner area.

7. An annular reactor according to claim 6, wherein the fins are oriented in an essentially longitudinal direction along a circumference of the central core structure.

8. An annular reactor according to claim 6, wherein the central core structure includes a hollow portion capable of housing other components.

9. An annular reactor according to claim 1, wherein the fins are arranged in a pattern including at least one of: straight, rectangular offset strip, offset strip, perforated, triangular, louvered, and wavy.

10. An anular reactor according to claim 9, wherein the fins are constructed to optimize at least one of: the heat transfer between the first fluid and the second fluid, a flow pattern of the first fluid or the second fluid within the respective inner area or the annular area, and to provide structural support between the inner cylinder and the outer cylinder.

11. An annular reactor according to claim 6, wherein the fins are arranged in a pattern including at least one of: straight, rectangular offset strip, offset strip, perforated, triangular, louvered, and wavy.

12. An annular reactor according to claim 11, wherein the fins are constructed to optimize at least one of: the heat transfer between the first fluid and the second fluid, a flow pattern of the first fluid or the second fluid within the respective inner area or the annular area, and to provide structural support between at least two of: the central core structure, the inner cylinder, and the outer cylinder.

13. An annular reactor according to claim 1, further comprising catalyst means for catalyzing a reaction to convert the first fluid into a desired end product.

14. An annular reactor according to claim 13, wherein the catalyst means is deposited on at least one of: the fins, the inner cylinder, and the outer cylinder.

15. An annular reactor according to claim 14, wherein the fins are arranged in a pattern including at least one of: straight, rectangular offset strip, offset strip, perforated, triangular, louvered, and wavy.

16. An annular reactor according to claim 15, wherein the fins are constructed to optimize at least one of: the heat transfer between the first fluid and the second fluid, a flow pattern of the first fluid or the second fluid within the respective inner area or the annular area, and to provide structural support between the inner cylinder and the outer cylinder.

17. An annular reactor according to claim 6, further comprising catalyst means for catalyzing a reaction to convert the first fluid into a desired end product.

18. An annular reactor according to claim 17, wherein the catalyst means is deposited on at least one of: the fins, the inner cylinder, the outer cylinder, and the central core structure.

19. An annular reactor according to claim 18, wherein the fins are arranged in a pattern including at least one of: straight, rectangular offset strip, offset strip, perforated, triangular, louvered, and wavy.

20. An annular reactor according to claim 19, wherein the fins are constructed to optimize at least one of: the heat transfer between the first fluid and the second fluid, a flow pattern of the first fluid or the second fluid within the respective inner area or the annular area, and to provide structural support between at least two of: the central core structure, the inner cylinder, and the outer cylinder.

21. An annular reactor assembly according to claim 13, wherein the catalyst means is in fluidic contact with the inner area and the annular area; wherein the catalyst means generates combustion reactions and hydrogen-reforming reactions; and wherein the combustion reactions occur in either the inner area or the annular area and the hydrogen-reforming reactions occurs wherever combustion reactions are not occurring.

22. An annular reactor according to claim 21, wherein there are two separate catalyst materials, the first catalyst material being specifically formulated to generate combustion reactions and the second catalyst material being specifically formulated to generate hydrogen-reforming reactions.

23. A method of constructing an annular reactor assembly comprising the steps of:
forming an inner cylinder having an inner space;
forming an outer cylinder;
forming a plurality of circumferential fins extending longitudinally along at least one of: an interior surface of the inner cylinder, an exterior surface of the inner cylinder and an interior surface of the outer cylinder;
subsequent to all of the forming steps above, concentrically arranging the inner cylinder and the outer cylinder to create an annular area between the inner cylinder and the outer cylinder;
subsequent to the arranging step above, providing manifolding and flow control devices to permit a first fluid to selectively flow through the inner space and a second fluid to selectively flow through the annular space; and
as a final step, sealing the assembly to prevent unwanted loss of the first fluid or the second fluid and to further prevent mixing of the first fluid and the second fluid.

24. A method of constructing an annular reactor according to claim 23, wherein the fins extend at least partially into the inner space and the annular space and wherein forming at least one of: the inner cylinder, the outer cylinder, the fins on the interior surface of the inner cylinder, the fins on the exterior surface of the inner cylinder and the fins on the interior surface of the outer cylinder, is accomplished using an extrudable material.

25. A method of constructing an annular reactor according to claim 23, wherein forming at least one of: the inner cylinder, the outer cylinder, the fins on the interior surface of the inner cylinder, the fins on the exterior surface of the inner cylinder and the fins on the interior surface of the outer cylinder, is accomplished using an EDM process and wherein the EDM process initially starts with a solid block of metal.

26. A method of constructing an annular reactor according to claim 23, wherein the fins extend at least partially into the inner space and the annular space and wherein forming at least one of: the fins on the interior surface of the inner cylinder, the fins on the exterior surface of the inner cylinder and the fins on the interior surface of the outer cylinder, is accomplished by attaching at least one finned strip to a circumference of the inner cylinder and/or outer cylinder.

27. A method of forming an annular reactor according to claim 26, wherein the subsequently attaching at least one finned strip includes a brazing process.

28. A method of constructing an annular reactor according to claim 26, wherein the finned strip has a pattern including at least one of: straight, rectangular offset strip, offset strip, perforated, triangular, louvered, and wavy.

30. A method of constructing an annular reactor according to claim 24, further comprising the step of, prior to concentrically arranging the inner cylinder and the outer cylinder, coating at least a portion of at least one of the: the inner cylinder, the fins of the inner cylinder, the outer cylinder, and the fins of the outer cylinder, with a catalyst material which induces a reaction to convert at least one of: the first fluid and the second fluid, into a desired end product.

31. A method of constructing an annular reactor according to claim 30, wherein the catalyst material is specifically selected to induce at least one of: a combustion reaction and a hydrogen-reforming reaction.

32. A method of constructing an annular reactor according to claim 25, further comprising the step of, prior to concentrically arranging the inner cylinder and the outer cylinder, coating at least a portion of at least one of the: the inner cylinder, the fins of the inner cylinder, the outer cylinder, and the fins of the outer cylinder, with a catalyst material which induces a reaction to convert at least one of: the first fluid and the second fluid, into a desired end product.

33. A method of constructing an annular reactor according to claim 32, wherein the catalyst material is specifically selected to induce at least one of: a combustion reaction and a hydrogen-reforming reaction.

34. A method of constructing an annular reactor according to claim 26, further comprising the step of, prior to concentrically arranging the inner cylinder and the outer cylinder, coating at least a portion of at least one of the: the inner cylinder, the fins of the inner cylinder, the outer cylinder, and the fins of the outer cylinder, with a catalyst material which induces a reaction to convert at least one of: the first fluid and the second fluid, into a desired end product.

35. A method of constructing an annular reactor according to claim 34, wherein the catalyst material is specifically selected to induce at least one of: a combustion reaction and a hydrogen-reforming reaction.

36. An in-line, annular reactor system, including heat transfer reactions and other reactions, comprising:
control means for selectively controlling heat transfer between a first fluid and a second fluid passing through the reactor system;
an upstream annular module having an inner outlet for providing a first fluid and an annular outlet for providing a second fluid; the upstream module being specifically designed to perform a specific pre-heat transfer reaction upon at least one of: the first fluid and the second fluid;
a downstream annular module having an inner inlet for receiving the first fluid and/or a derivative of the first fluid and an annular inlet for receiving the second fluid and/or a derivative of the second fluid; the downstream module being specifically designed to perform a specific post-heat transfer reaction upon at least one of: the first fluid, the derivative of the first fluid, the second fluid, and the derivative of the second fluid; and
a heat transfer module having: an inner cylinder which encloses an inner area, the inner area being in fluidic connection with the inner outlet of the upstream module and the inner inlet of the downstream module; an outer cylinder which encloses the inner cylinder and forms an annular area between the inner cylinder and the outer cylinder, the annular area being in fluidic connection with the outer outlet of the upstream module and the outer inlet of the downstream module; and a plurality of fins positioned in a substantially longitudinal direction along a circumference of at least one of: the inner area of the inner cylinder and the annular area of the inner cylinder and the outer cylinder; the heat transfer module being specifically designed for transferring heat between the first fluid and the second fluid.

37. The in-line, annular reactor system of claim 36, wherein the inner area and the annular area of the heat transfer module each contain catalyst means for, concurrent with the heat transfer, converting at least one of: the first fluid and the second fluid, into a desired derivative thereof.

38. The in-line, annular reactor system of claim 37, wherein the catalyst means is specifically designed to perform hydrogen reforming; wherein the derivative of the first fluid and/or the derivative of the second fluid includes hydrogen-rich gas; and wherein the pre-heat transfer reaction and the post-heat transfer reaction both include reactions commonly required by a fuel processing system.

39. The in-line, annular reactor system of claim 38, wherein the reactions commonly required by a fuel processing system include at least one of: desulfurization, pre-reforming heat transfer, post-reforming heat transfer, selective oxidation, partial oxidation, and water-gas shift reactions.

40. The in-line, annular reactor system of claim 36, wherein the fins are arranged in a pattern which includes at least one of: straight, rectangular offset strip, offset strip, perforated, triangular, louvered, and wavy.

41. An annular reactor according to claim 40, wherein the fins are constructed to optimize at least one of: the heat transfer between the first fluid and the second fluid, a flow pattern of the first fluid or the second fluid within the respective inner area or the annular area, and to provide structural support between at least two of: the central core structure, the inner cylinder, and the outer cylinder.

42. The in-line, annular reactor system of claim 36, wherein the control means comprises a variable cover.

43. An annular reactor according to claim 42, wherein the variable cover comprises plurality of of overlapping plates fixed to a central pivot.

44. An annular reactor according to claim 42, wherein the variable cover comprises an expanding fan fixed to a central pivot.

45. An annular reactor according to claim 36, wherein the control means includes an automated system for monitoring at least one of: the first fluid and the second fluid, and for responsively altering the heat transfer between the first fluid and the second fluid in order to achieve a desired operating state.
